(19) United States
(12) Patent Application Publication
(10) Pub. No.: US 2014/0110617 A1
(43) Pub. Date: Apr. 24, 2014

(54) PLUG VALVE WITH INTEGRATED HARD FACE SEAT

(71) Applicant: PGI INTERNATIONAL, LTD., Houston, TX (US)

(72) Inventor: Peter Mark Middleton, Houston, TX (US)

(73) Assignee: PGI INTERNATIONAL, LTD., Houston, TX (US)

(21) Appl. No.: 13/659,486

(22) Filed: Oct. 24, 2012

(51) Int. Cl. F16K 5/04

(52) U.S. Cl. 251/309; 137/15.24

(57) ABSTRACT

A plug valve includes a valve body (10) and a valve stem (30) supporting a plug (32). A seat is formed on and is integral with the valve body. The seat includes a seating surface (16) above and below the passageway connecting the fluid inlet and the fluid outlet. The seating surface provides a seal with the plug. A method of forming the seat on the valve body is disclosed.

### FIELD OF THE INVENTION

The present invention relates to plug valves and, more particularly, to plug valves suitable for high temperature and/or high pressure applications. The invention is also directed to a plug valve having a seat formed directly on the valve body.

### BACKGROUND OF THE INVENTION

Prior art plug valves conventionally utilize an inserted cone with a seat that is machined outside the valve body, and then inserted and glued into a pre-machined cone shaped pocket with tight tolerance in the valve body. The metal cone generally has a raised lip around its interior frustoconical shape. This combines with a tight tolerance on the insert outer surface, to provide a leak free seal once the stem and cone are engaged and forced down into the inserted seat cone.

The prior art has significant problems when a minimum diameter seat size is utilized. The intricate machining and small size of the seat means that the tolerance is extremely difficult to hold and therefore a seal is very difficult to maintain. The raised interior lip is difficult if not impossible to replicate once the valve bore size becomes smaller than 0.250″. A hard face seat insert is disclosed in U.S. Pat. No. 4,776,566. Moreover, this prior art assembly is time consuming and difficult to manufacture, involving the use of special glues and heat treatment to ensure proper cone placement and a seal with the plug. If these steps are not performed accurately, the chances of a leaking valve are inherently increased.

The disadvantages of the prior art are overcome by the present invention, an improved plug valve is hereinafter disclosed.

### SUMMARY OF THE INVENTION

In one embodiment, a plug valve comprises a valve body having a flow line connecting a fluid inlet and a fluid outlet. A valve stem having a plug supported on an end thereof controls flow through the valve body. A seat formed on the valve body includes a seating surface above and below the flow line, and provides the seating surface for sealing engagement with the plug.

These and further features and advantages of the present invention will become apparent from the following detailed description, wherein reference is made to the figures in the accompanying drawings.

### BRIEF DESCRIPTION OF THE DRAWINGS

FIG. 1 is a top view of a seat machined into a valve body.

FIG. 2 is a front cross-sectional view of a machined surface seat in the valve body.

FIG. 3 is a side cross-sectional view of the seat machined into the valve body.

FIG. 4 is a cross-sectional view showing interaction of a cone on a valve stem with a seat in the valve body.

### DETAILED DESCRIPTION OF PREFERRED EMBODIMENTS

This invention provides a method that utilizes a raised hard face seat formed on the valve body of a plug type valve in order to successfully seal with the plug. In preferred embodiments, a bubble tight seal may be formed using a metal-to-metal sealing surface. The seal utilizes the shape of a frustoconical seat surface to provide a surface area of such size such that the interaction between the frustoconical plug and seat will result in sufficient contact pressure to initiate and hold the seal at high pressures.

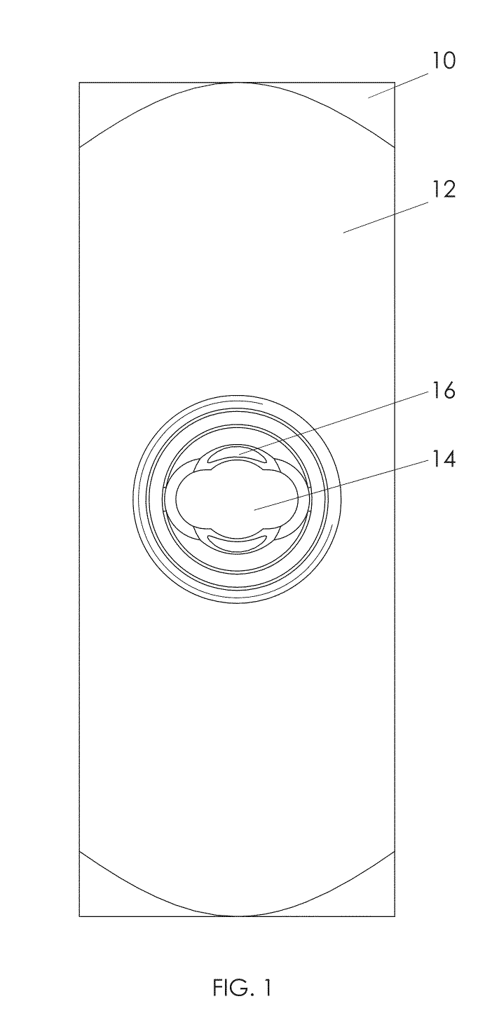

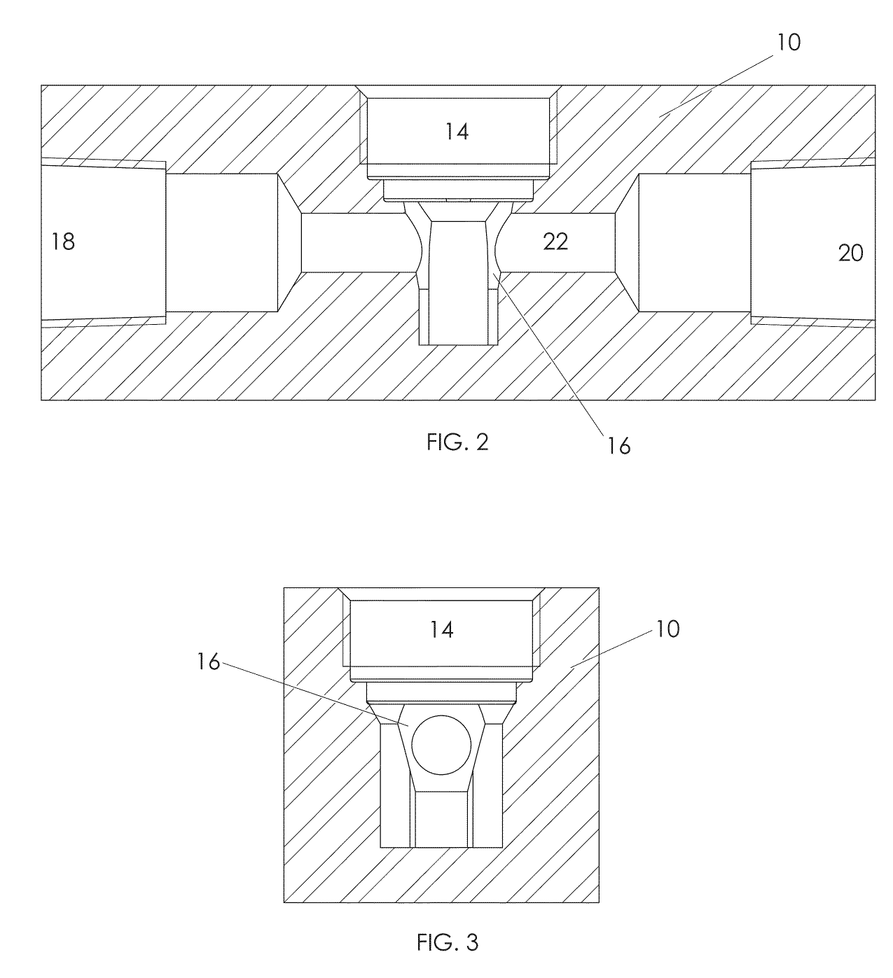

FIG. 1 is a top view of a valve body 10 having a substantially upper surface 12 and a pocket 14 therein forming a seat 16 machined from the valve body. As shown in FIG. 2, the valve body 10 includes an inlet 18 and an outlet 20 which pass fluid in a substantially linear manner though a passageway 22 in the valve body, with the passageway being roddable. FIG. 2 shows pocket 14 and machined seating surfaces 16 which engage a plug member to close off flow through the valve.

FIG. 3 is another cross-sectional view of the valve body 10 illustrating the machined seating surfaces 16. As shown in FIGS. 2 and 3, the machined seating surfaces are provided for engagement with a plug at locations both above and below the passageway 22 through the valve body. The seat surfaces 16 are thus formed on and are integral with the valve body 10.

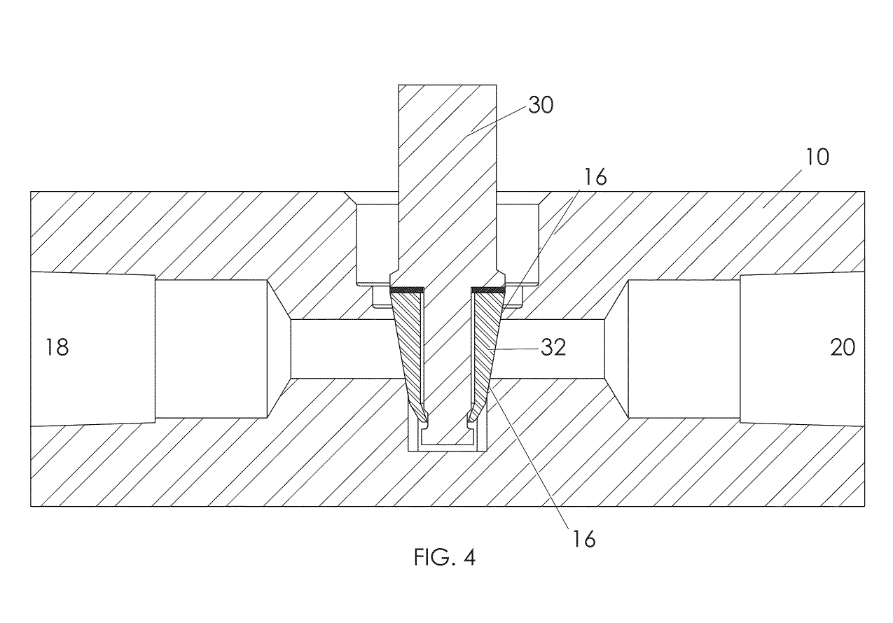

FIG. 4 discloses the valve body 10 with a valve stem 30 and plug 32 at a lower end thereof. Forcing the plug 32 downward into the pocket thus creates a metal-to-metal seal between the frustoconical outer surfaces of the plug 32 and the mating metal surfaces of the seat 16.

As disclosed herein, the plug valve is able to maintain sealing capabilities at high temperatures, while also providing a roddable design and retaining an instrument plug/needle valve configuration. Currently, there is no known small bore valve that still retains the ability to seal at high temperatures while maintaining roddability. Roddability is the ability to use a tool of some sort to unclog or clean out a blocked valve though a bore that is free of obstructions. This feature results from a flow line through the valve body which has a substantially straight line axis. High temperatures are defined as those outside the capabilities of soft and composite seat offerings, and typically will be over 700° F. The prior art generally maintains a common configuration of a steel ball bearing being pushed into a seat pocket. An abrupt turn is necessary in the flow bore of these valves, so they are not truly roddable.

A further feature of the valve is that if there was some form of leakage occurring during field use, a lapping of the seat may be performed in situ to remove striations or damage that may occur due to extreme use from aggressive media stream. This extends the life of the valve and makes it possible to field dress the seat and provide a temporary fix until a replacement valve could be scheduled for insertion.

A method of machining is provided that forms a seat that is vertical to the valve body. This removes the need for the usual required seat inserts. The techniques disclosed herein are particularly well suited for dealing with very small bore and small seat valves, but may also be used on larger bore and large seat valves. The technique reduces the number of moving parts and provides a solution that allows a hard face raised seat to be machined into a valve body, resulting in a metal-to-metal seal that is capable of high temperature bubble tight leakage.

The shape of the seat on the valve body is frustoconical, and is raised from its surrounding area. The raised structure results in a downward force produced during the closing of the valve pushing on the cone, which is translated to contact pressure at the seat seal area producing the required force for effective sealing.

The present invention reduces the number of parts required to make a seal and provides a configuration that is far easier to machine. No specialized tooling and CNC machining is necessary. By making the raised lips of the seat integral with the valve body, it is possible to produce a reliable seat in four steps using only a vertical mill. Moreover, the seat should have a greater longevity since material is left whole behind the seat, providing a seat which is field serviceable via a lapping process if the seat becomes damaged.

A four step machining process is disclosed, with each step removing a specific volume of metal that helps keep the shape and raised face profile to the seat. An initial drill of specific size is plunged into the center of the seat. An end mill may then be utilized to remove a swath of material on either side of the central plunged hole. A tapered end mill of specific angular and end dimension is then plunged down the previous center hole, creating the needed frustoconical shape. The top of the seat pocket is then finished with a double edge chamfer tool to finish the raised seat profile and ensure the desired surface will provide the needed seating stress. The surface finish of the machined seat face is important in this process and all burrs and chips may be removed after machining. To obtain an initial seal, or after use of the valve, the seat may need to be lapped using a lapping compound and lapping devices. This guarantees a surface finish and ensures the angle of the cone and the seat is matched as close as possible.

The valve as described herein uses a plug to seal with the seat formed on the valve body. The term “plug” is used herein for a valve includes needle valves with slender plug members.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. A plug valve, comprising:
a valve body having a flow line connecting a fluid inlet and a fluid outlet;
a valve stem having a plug supported on an end of the valve stem for controlling flow through the valve body; and
a seat formed on and integral with the valve body and including a seating surface above and below the flow line interconnecting the fluid inlet and the fluid outlet, the seating surface providing a seal with the plug.

2. The plug valve as defined in claim 1, wherein the plug has an exterior metal surface, and wherein the seat on the valve body has a metal interior surface, such that a metal-to-metal seal is made between the plug and the seat.

3. The plug valve as defined in claim 1, wherein the plug and seat are able to reliably withstand a temperature in excess of 700° F.

4. The plug valve as defined in claim 4, wherein the flow line between the fluid inlet and the fluid outlet has a substantially straight line axis.

5. The plug valve as defined in claim 4, wherein the flow line between the fluid inlet and the fluid outlet is roddable.

6. The plug valve as defined in claim 1, wherein the seat is formed by the initial drill into the center of the seat, followed by an end mill to remove a swath of material on the side of the hole in the seat, followed by a tapered end mill creating a desired frustoconical shape, followed by chamfer tool to finish the raised seat profile.

7. The plug valve as defined in claim 1, wherein the seat is lapped after use to remove striations.

8. A plug valve, comprising:
a valve body having a flow line connecting a fluid inlet and a fluid outlet;
a valve stem having a plug supported on an end of the valve stem for controlling flow through the valve body, the plug having an interior metal surface; and
a seat formed on and integral with the valve body, the seat including a seating surface above and below the flow line interconnecting the fluid inlet and the fluid outlet, the seating surface providing a seal with the plug, the seat on the valve body having a metal interior surface, such that a metal-to-metal seal is made between the plug and the seat.

9. The plug valve as defined in claim 8, wherein the flow line between the fluid inlet and the fluid outlet has a substantially straight line axis.

10. The plug valve as defined in claim 9, wherein the flow line between the fluid inlet and the fluid outlet is roddable.

11. The plug valve as defined in claim 9, wherein the seat is formed by the initial drill into the center of the seat, followed by an end mill to remove a swath of material on the side of the hole in the seat, followed by a tapered end mill creating a desired frustoconical shape, followed by chamfer tool to finish the raised seat profile.

12. The plug valve as defined in claim 9, wherein the seat is lapped after use to remove striations.

13. A method of sealing a plug valve, comprising:
providing a valve body having a flow line connecting a fluid inlet and a fluid outlet;
supporting a plug on an end of the valve stem for controlling flow through the valve body; and
forming a seat on and integral with the valve body, the seat including a seating surface above and below the flow line interconnecting the fluid inlet and the fluid outlet, the seating surface providing a seal with the plug.

14. The method as defined in claim 13, wherein the plug has an exterior metal surface, and wherein the seat on the valve body has a metal interior surface, such that a metal-to-metal seal is made between the plug and the seat.

15. The method as defined in claim 13, wherein the plug and seat are able to reliably withstand a temperature in excess of 700° F.

16. The method as defined in claim 13, wherein the flow line between the fluid inlet and the fluid outlet has a substantially straight line axis.

17. The method as defined in claim 16, wherein the flow line between the fluid inlet and the fluid outlet is roddable.

18. The method as defined in claim 13, wherein the seat is formed by the initial drill into the center of the seat, followed by an end mill to remove a swath of material on the side of the hole in the seat, followed by a tapered end mill creating a desired frustoconical shape, followed by chamfer tool to finish the raised seat profile.

19. The method as defined in claim 13, wherein the seat is lapped after use to remove striations.
